(19) United States
(12) Patent Application Publication
(10) Pub. No.: US 2016/0196008 A1
(43) Pub. Date: Jul. 7, 2016

(54) IMPLEMENTING DESKTOPS ON A MOBILE TERMINAL

(71) Applicant: Alibaba Group Holding Limited, George Town (KY)

(72) Inventor: Chao Hua, Hangzhou (CN)

(21) Appl. No.: 14/987,345

(22) Filed: Jan. 4, 2016

(30) Foreign Application Priority Data
Jan. 7, 2015 (CN) 201510007279.0

(51) Int. Cl. G06F 3/0481; H04L 29/06

(52) U.S. Cl. CPC G06F 3/0481; H04L 69/22

(57) ABSTRACT

Embodiments of the present application relate to a method and apparatus for implementing desktops. The method includes receiving a data packet including desktop service data, obtaining interface layout information from the data packet, and creating one or more display interfaces on a desktop based at least in part on the interface layout information, wherein the one or more display interfaces display at least a part of the desktop service data.

### CROSS REFERENCE TO OTHER APPLICATIONS

This application claims priority to People's Republic of China Patent Application No. 201510007279.0 entitled A METHOD AND DEVICE FOR IMPLEMENTING DESKTOPS, filed Jan. 7, 2015 which is incorporated herein by reference for all purposes.

### FIELD OF THE INVENTION

The present invention involves the field of user interfaces, in particular, the present application relates to a method, system, and device for implementing desktops.

### BACKGROUND OF THE INVENTION

As a result of the popularization and development of mobile terminals, mobile terminals have gradually transitioned from tools whereby users merely communicate to becoming important means of acquiring information. A large number of merchants also use mobile devices as tools that provide services to users. Similarly, as a result of the popularization of mobile terminals and the evolution of mobile terminals that provide relatively advanced features and applications to users, mobile terminals provide interfaces from which users directly view relevant information.

Conventional mobile terminals provide desktops that display interfaces configured by the desktop programs. These conventional desktops typically use App Widget technology to display third party content so as to achieve a personalized desktop effect. Existing mobile terminals generally provide display interfaces according to two conventional approaches.

The first conventional approach to providing display interfaces includes display templates of interfaces that were abstracted in advance. The interfaces are formed on the desktop by populating the corresponding display templates with data from a server. However, interfaces that use this approach are hard-coded in desktop programs. Accordingly, the layout of the interfaces cannot be easily changed according to a current need. For example, in order for the layout to be changed, new display templates corresponding to the changed layout need to be coded into the desktop program. As a result, the first approach to providing display interfaces has very poor flexibility; the cost and requisite resources associated with changing the desktop are very high; in addition, a desktop developer needs to be highly proficient with the business logic of display interfaces.

The second conventional approach to providing display interfaces includes pre-developed App Widget programs. Such App Widget programs are installed and run on mobile terminals. A personalized desktop display is provided to the user using the App Widget programs. However, such an approach suffers from the following defects: the user needs to install the App Widget program manually; the displayed interface can only be an interface with a relatively simple logic because of the technical architecture of an App Widget; and all interface event processing is carried out in the App Widget program. The second approach to providing display interfaces is thus relatively inflexible. As a practical matter, it is nearly impossible to realize desktop-based interface display interactions using App Widget programs.

### BRIEF DESCRIPTION OF THE DRAWINGS

Various embodiments of the invention are disclosed in the following detailed description and the accompanying drawings.

FIG. 1A is a flow chart of a method for providing information to a mobile terminal in connection with implementing a display interface according to various embodiments of the present disclosure.

FIG. 1B is a flow chart of a method for implementing a display interface according to various embodiments of the present disclosure.

FIG. 2 is a block diagram of a display interface according to various embodiments of the present disclosure.

FIG. 3A is a block diagram of a device for implementing a display interface according to various embodiments of the present disclosure.

FIG. 3B is a block diagram of a device for implementing a display user interface according to various embodiments of the present disclosure.

FIG. 4 is a block diagram of a device for implementing a display user interface according to various embodiments of the present disclosure.

FIG. 5 is a diagram of a system for implementing a display interface on a mobile terminal according to various embodiments of the present disclosure.

FIG. 6 is a functional diagram of a computer system for implementing a display interface according to various embodiments of the present disclosure.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

According to various embodiments of the present disclosure, data packets of desktop service data sent to mobile terminals carry (e.g., include) interface layout information that enables the mobile terminals to analyze the data packets, to obtain interface layout information from such data packets, to create display interfaces on the desktops (of the mobile terminals) in accordance with the interface layout information, and to display the desktop service data in the created display interfaces.

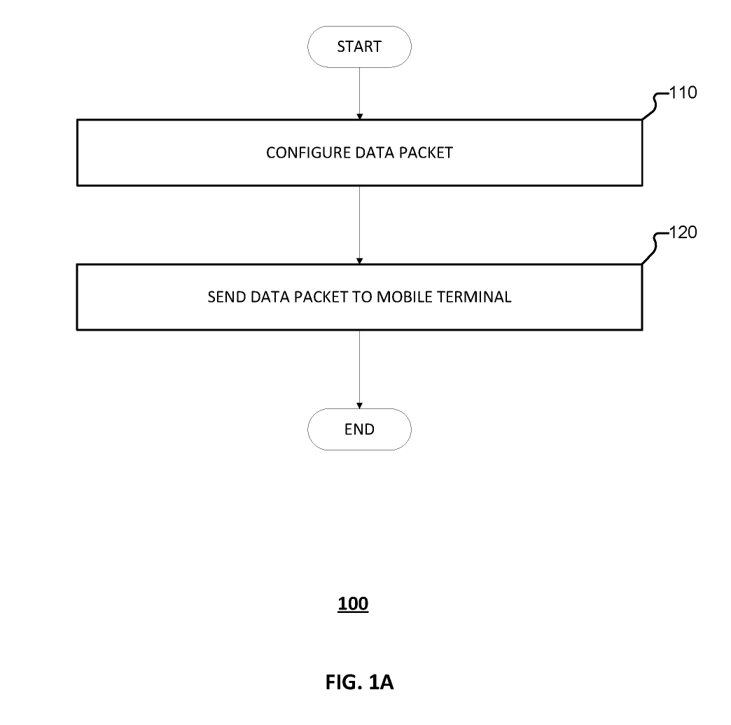

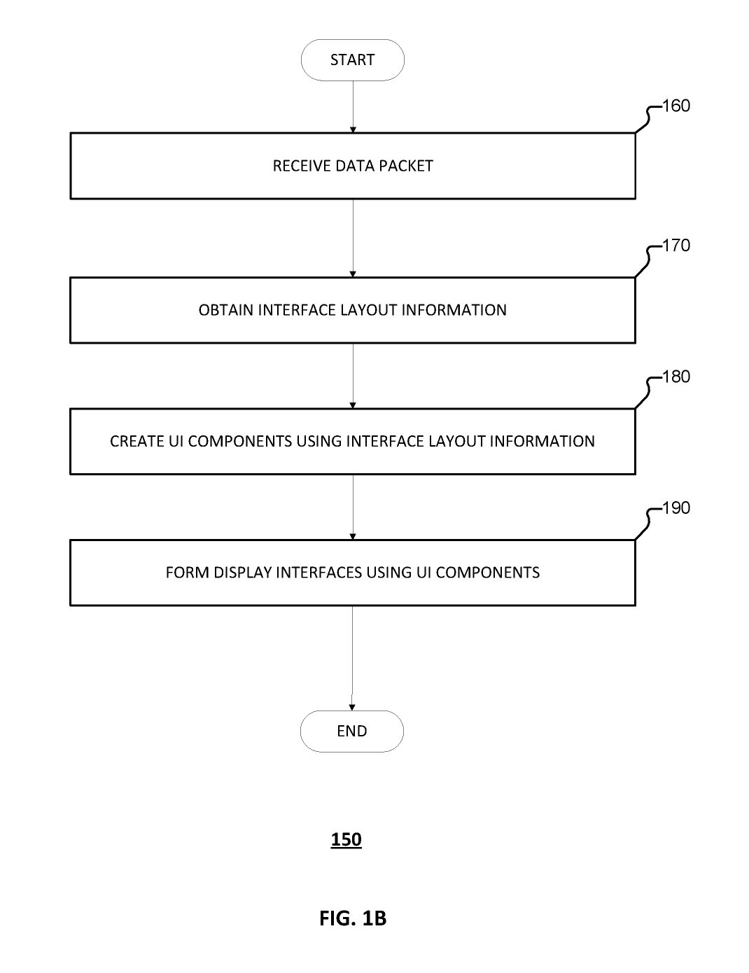

FIG. 1A is a flow chart of a process for providing information to a mobile terminal in connection with implementing a display interface according to various embodiments of the present disclosure.

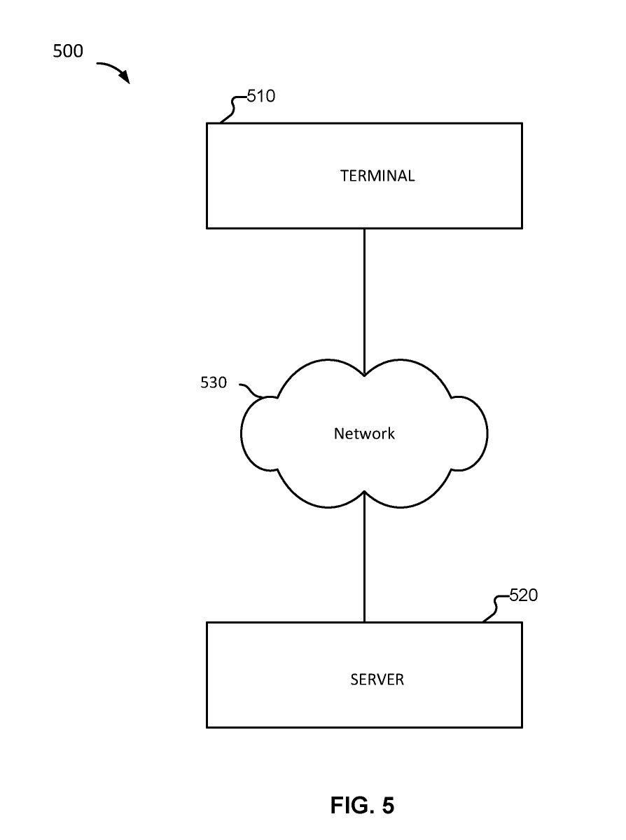

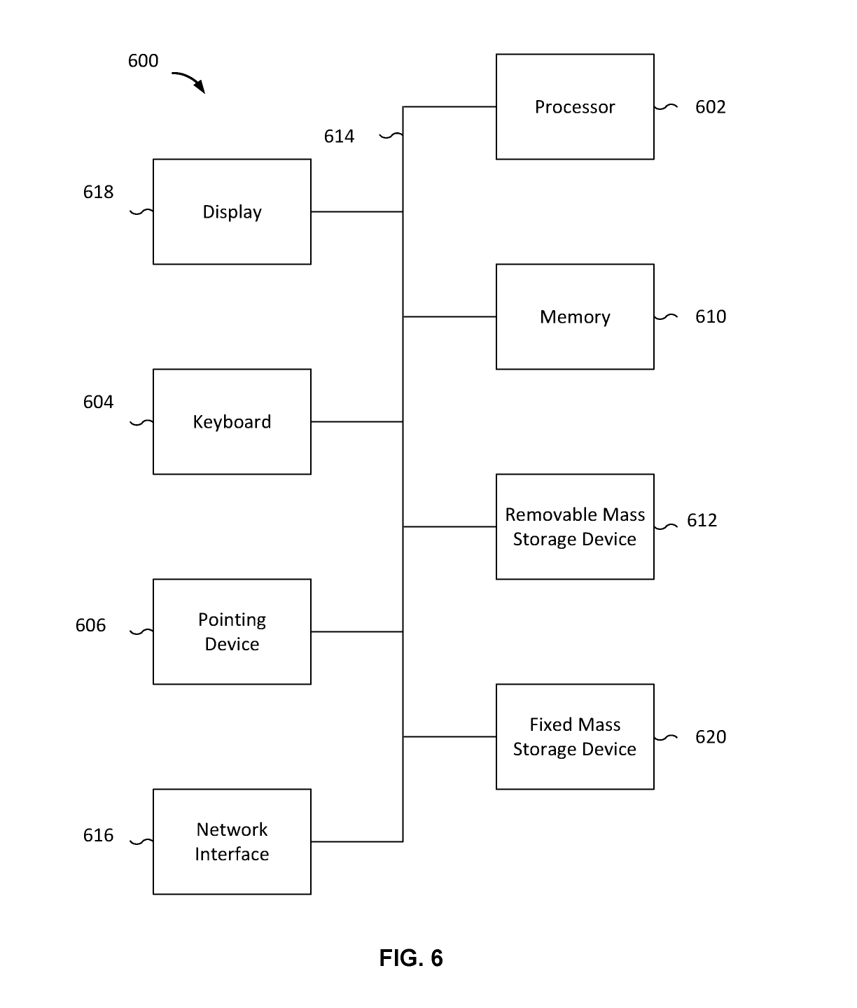

Referring to FIG. 1A, process 100 for providing information to a mobile terminal in connection with implementing a display interface thereon is provided. Process 100 can be implemented by, for example, server 520 of system 500 of FIG. 5, or computer system 600 of FIG. 6.

At 110, a server configures a data packet. As used herein, a data packet refers to a set of data that can be transferred from the server to a client at the application level. A data packet can include one or more lower level networking packets (e.g., TCP/IP packets). In some embodiments, the data packet is formatted to include various data fields. In some embodiments, the data packet includes desktop service data such as content data. In some embodiments, the data packet includes interface layout information such as locations of icons, spacing information, etc. In some embodiments, layout information corresponds to information associated with a layout by which a corresponding desktop service data is to be provided. The interface layout information can be used to determine desktop services data in connection with presenting the desktop.

At 120, the data packet is sent to a mobile terminal. In some embodiments, the server can send the data packet to the mobile terminal in response to receiving (directly or indirectly) a request for information from the mobile terminal. For example, the server can send a data packet including desktop service data to a mobile terminal that ordered the desktop service. As an example, a server that provides, or is otherwise associated with, a news service can send a data packet comprising news information to a mobile terminal that ordered the news desktop service. The server can send (e.g., push) such a data packet including the news information to a mobile terminal that is a subscriber (e.g., a mobile terminal associated with a user account that is a subscriber) to the news desktop service. The news information would be primarily for display on the desktop. As another example, a server that provides, or is otherwise associated with, a video service can send a data packet including video information to a mobile terminal that ordered the video desktop service. The server can send (e.g., push) such a data packet including the video information to a mobile terminal that is a subscriber (e.g., a mobile terminal associated with a user account that is a subscriber) to the video desktop service. The video information would be primarily for display on the desktop. Various other services can be provided by servers, and corresponding data packets including information associated with the various other services can be sent to a mobile terminal in connection with the display of at least a part of the information on the desktop.

In some embodiments, the server sends the data packet in response to a request from the mobile terminal. In some embodiments, the server sends the data packet at predetermined times (e.g., at a preset time interval, or at a time when one or more conditions, such as conditions relating to a context of the mobile terminal, are satisfied). For example, the server can actively push a data packet of desktop service data to the mobile terminal. In some embodiments, a mobile terminal requests data from the server in connection with creating a desktop following activation. The activation and the request can be specified according to a standard protocol such as HTTP, or a proprietary protocol implemented between the server and the client.

The data packets sent by the server to the mobile terminal can carry (e.g., include) various types of information or content. In some embodiments, the data packets sent by the server primarily carry three types of content: desktop service data, interface layout information, and attribute information for desktop service data. Various types of content that can be carried in the data packets are described further below.

In some embodiments, desktop service data corresponds to specific content data. For example, the desktop service data can include text data, image data, video data, etc. The particular content data corresponding to the desktop service data can be dependent on the specific service associated with the desktop service being provided. For example, desktop service data corresponding to a video desktop service can include at least video data. As another example, desktop service data corresponding to a news desktop service can include at least text data (that is associated with news such as current events, or the like).

In some embodiments, the interface layout information is related to the desktop service data. For example, the interface layout information included in the data packet corresponds to the specific desktop service data included in the data packet. The interface layout information can correspond to a specific desktop service being provided in connection with the desktop service data. The conventional approaches to providing display interfaces do not include the communication of interface layout information from a server (e.g., associated with a desktop service being provided to the mobile terminal) to the mobile terminal. In some embodiments, interface layout information corresponds to information associated with how the desktop service data (or a portion thereof) is laid out when such desktop service data is displayed on the desktop of the mobile terminal. For example, the interface layout information provides information indicating how corresponding desktop service data is to be presented by the mobile terminal. The interface layout information can provide parameters for presenting the desktop service data. The interface layout information is used in connection with the mobile terminal creating the display interfaces that are used to display the desktop service data.

In some embodiments, the interface layout information comprises display unit information and user interface (UI) component information included in the display units. As used herein, a display unit refers to a unit of data to be displayed. One or more display units can be freely defined through the interface layout information. Each display unit can correspond to a display interface on the desktop. For example, on a mobile device configured to run the Android® operating system, the display interfaces can be implemented using objects such as Canvases and preferably the form of web page Canvases (e.g., Views).

According to various embodiments, different types of data can be presented in a single display unit, or different types of data can be presented separately in different display units. Implementation of presenting different types of data in one or more display units is flexible. According to various embodiments, the layout of one or more types of data in relation to one or more display units is determined on the server side. For example, if the desktop service data issued by the server includes images and text, then the images and text can be displayed in a single display unit. Determination of how to present the various types of data (e.g., text data and image data) can be based at least in part on the interface layout information. In addition, determination of how to present the various types of data can be further based at least in part on user settings corresponding to the user associated with the mobile terminal, or the like. The server can determine whether the text data and the image data included in the desktop service data are to be presented in a single display unit, or whether the text data and the image data are to be presented in different display units (or across two or more display units). Accordingly, the interface layout information of the issued data packet can include information for just one display unit, and such a display unit would include textual UI component information and also image UI component information. The images and text could also be separately displayed in different display units. In the event that the images and the text are to be separately displayed (e.g., respectively in an image display unit and a text display unit), the image display unit includes image UI component information, and the text display unit includes text UI component information.

In some embodiments, the display unit information includes configuration information associated with the presentation of interface layout information. For example, the display unit information can include display unit quantity information (e.g., indicating a number of display units over which the interface layout information is to be presented), display unit position information, and any other appropriate information associated with display presentation. In some embodiments, the UI component information included in a display unit includes: component type (e.g., image component, text component, etc.), component position, component size, component color, component shape, and other such information. In addition, the UI component information can include response information vis-à-vis user operation events. As an example, user operation events can include but are not limited to user's clicking, dragging, or sliding of the UI components. The response information for operation events is used in describing user operation event responses. An example user operation event is a click event. When a user clicks a component, it is generally a data request event. To reduce the processing required for the event, it is possible to designate a URL request corresponding to the click event. For example, in response to the user clicking the component, the data corresponding to a pre-specified URL is requested and/or acquired.

In some embodiments, interface layout information is used to draw the interface attributes such as font size, location, etc., and desktop services interface information generally includes specific content, such as content of the text, picture content, etc.

The way in which the above-described layout information is communicated can be based on any data protocol format agreed upon by the server and the mobile terminal. In some embodiments, JavaScript Object Notation (JSON) format is used. One example of a JSON file describing layout information is below:

{“ViewNum”:“2”,“content”:
[{“ViewType”:“0”,
“position”:“0:0:320:460”,“OnclickEnable”:“0”,
“ViewUrl”:“img03.taobaocdn.com”,“txtSrc”:“The
file content is displayed here”,“TextSize”:“13”,
“TextColor”:“0”,“TextMaxLines”:“1”},
{“ViewType”:“1”,“position”:“320:460:480:600”,
“OnclickEnable”:“0”,“ViewUrl”:“img03.taobaocdn.com”,
“ImgSrc”:“http://img03.taobaocdn.com/tps/i3/
T1JDV9FNBXXXc_d6ve-16080.jpg”, “ImageScaleType”:“fitxy”,
“ImageCornersType”:“0”, “ImageCornerAngle”:“0”}]}

In the above example, the “ViewNum” field can be used to indicate display unit quantity information. In the above example, the field value is “2,” which indicates that two display units are contained (e.g., that information for two display units is being provided in connection with the desktop service data).

In the component information included in the display units, the “ViewType” field indicates component type. The field value “0” can indicate a text component, and the field value “1” can indicate an image component. Various other representations can be used to denote various types of data. For purposes of describing various embodiments below, it is assumed that the component information includes one text component and one image component.

The “position” field can be used to indicate the component position. For purposes of describing various embodiments below, the position of the text component can be represented as coordinates and can be assumed to be (0:0:320:460), and the position of the image component can be assumed to be (320:460:480:600).

The “txtSrc” field can be used to indicate the content of a text component. The content of the “txtSrc” can be the content of the desktop service data.

The “TextSize” field can be used to indicate text component size. For purposes of describing various embodiments below, the size of the text component can be assumed to be 13 dp.

The “TextColor” field can be used to indicate text component color.

The “TextMaxLines” field can be used to indicate the maximum number of lines in text display. For purposes of describing various embodiments below, the maximum number of lines can be assumed to be one line.

The “ImgSrc” field can be used to indicate the content of an image component. The content of the “ImgSrc” can be the content of the desktop service data. In some embodiments, the content can be an image to which a specific URL is directed.

The “ImageScaleType” field can be used to indicate image component size. The “ImageCornersType” field can be used to indicate types of image corners. The “ImageCornerAngle” field can be used to indicate angles of image corners. For purposes of describing various embodiments below, all four corners of the image can be assumed to be rounded.

The “OnclickEnable” field can be used to indicate whether click events are responded to. The “ViewUrl” field can be used to indicate the URL that is accessed in response to the click event (e.g., the URL request corresponding to the click event).

In some embodiments, attribute information for desktop service data includes data expiration status information, data display IDs (identifiers), etc.

The expiration status information corresponding to data indicates the time information for display of service data on the desktop. For example, the expiration status information can be used to determine when the service data is to be presented. The expiration status information can indicate or otherwise be used to determine when or how long the service data is valid. After the time corresponding to the time information elapses, the desktop no longer provides display of the corresponding desktop service data. The expiration status of data is generally used in connection with (e.g., when) the mobile terminal deleting display interfaces.

In some embodiments, data display IDs are unique identifiers that indicate the associations of servers to mobile terminals. The data display IDs can be generated by a display server. In some embodiments, the server can use the data display IDs to update the same class show ID cards. For example, the data display IDs can be used in connection with updating the information on a card associated with movie “Harry Potter” to be associated with a different movie after the update. As an example, the server can push information relating to the “Pacific Rim” movie and the movie card ID can be used to update such cards to include the information relating to the “Pacific Rim” movie. The data display IDs can correspond to display interfaces on the desktop. For example, the data display IDs can be used by a mobile terminal when the mobile terminal makes a data request to the server or when the mobile terminal updates data. If the server issues data for a single desktop service, the same data display IDs can be used, or different data display IDs can be used. Whether the same data display ID or different data display IDs are used in connection with a server issuing data for a single desktop service can be flexibly configured at the server side. If the same data display ID is used, the mobile terminal uses the content in the data packet to carry out data updating of existing display interfaces. If different data display IDs are used, the mobile terminal creates display interfaces that display the content in the corresponding data packet.

In some embodiments, in addition to using a server to send data packets to mobile terminals, it is also possible to use other equipment to send data packets containing interface layout information to mobile terminals.

FIG. 1B is a flow chart of a method for implementing a display interface according to various embodiments of the present disclosure.

Referring to FIG. 1B, process 150 for implementing a display interface thereon is provided. Process 150 can be implemented by terminal 510 of system 500 of FIG. 5, or computer system 600 of FIG. 6.

At 160, a data packet is received. For example, a mobile terminal receives the data packet from a server. The data packet received by the terminal can correspond to the data packet configured and sent to the mobile terminal in connection with process 100 of FIG. 1A. In some embodiments, the data packet includes desktop service data. The data packet can be received by the mobile terminal in connection with a desktop service ordered (e.g., subscribed) to by the mobile terminal.

At 170, interface layout information is obtained. For example, the mobile terminal obtains the interface layout information after the mobile terminal parses the data packet to obtain interface layout information. Additional analysis of the data packet can be performed. In some embodiments, the interface layout information includes UI component information. For example, the UI component information can be included in a display unit comprised in the interface layout information. The mobile terminal can extract the display unit(s) and/or the UI component information from the interface layout information. In some embodiments, the mobile terminal uses the UI component information contained in the display units in the interface layout information to create UI components for constructing objects such as view container objects supported by the Android SDK corresponding to the display units. In some embodiments, the view container objects corresponds to a container carrying each interface displayed on the desktop. An interface can correspond to a carrier and is the desktop to provide a component for storing a single display unit.

After the mobile terminal analyzes the received data packet, it obtains interface layout information. The quantity of display units contained in the interface layout information corresponds to the quantity of display interfaces created by the mobile terminal in relation to the data packet. The quantity of displays units can have a one-to-one relationship with the quantity of display interfaces.

At 180, UI components are created. In some embodiments, the UI components are created based at least in part on the interface layout information obtained from the data packet(s). For example, the mobile terminal can use the interface layout information to create UI components in response to the interface layout information being obtained or in response to a request from an application or the like to display an interface that is to include UI components.

In some embodiments, the UI component information included in each display unit is individually used to create a corresponding UI component. For example, UI components are created based at least in part on component type, position, size, color, and other such information. The desktop program performs the UI component creation within its memory first. For example, before displaying the UI component, the desktop program creates the UI component and stores such UI component to memory. In some embodiments, the UI components of each display unit form a view container object corresponding to each display unit.

At 190, display interfaces are formed. In some embodiments, the display interfaces are formed using the UI components created based at least in part on the interface layout information obtained from the data packet(s). The mobile terminal can use the desktop service data in the data packet to fill the view containers and render the view containers on the desktop to form display interfaces corresponding to the various display units.

In some embodiments, the view containers created (e.g., by the mobile terminal and stored within its memory) at 180 correspond to containers that define each view parameter. In some embodiments, such view parameters are embodied through UI components. A view parameter can be used to draw the view and can refer to the properties of the view, such as width and height of the view, text font, etc. In some embodiments, the forming of the display interfaces at 190 comprises filling specific data content (e.g., desktop service data) into the view containers. A view container can be rendered on the desktop while data is being filled in (e.g., contemporaneous with the filling of the container with the corresponding data), or after data is filled in. The display interface corresponding to each display unit is thus formed.

As discussed above, the display unit information can comprise position information for the display units. The view container can be rendered on the desktop in accordance with the position information of the display unit. For example, in connection with the forming of the display interfaces at 190 (e.g., the rendering of the view container), the view container can be rendered on the desktop based at least in part on the position information of the display unit. By setting position information for display units, the server can flexibly place display interfaces in various positions on the desktop. For example, the setting can be to place a display interface in an eye-catching position such as the center of the desktop. The location at which the display interface is provided is configurable by the server or the like.

In some embodiments, the size of the display interfaces can be adapted according to the layout status of the UI components therein. For example, the size of the display interface can be configured to ensure that all UI components in the corresponding view container are accommodated. As another example, additionally or alternatively, the size of the display interface can be configured to ensure that preset display ratios are followed.

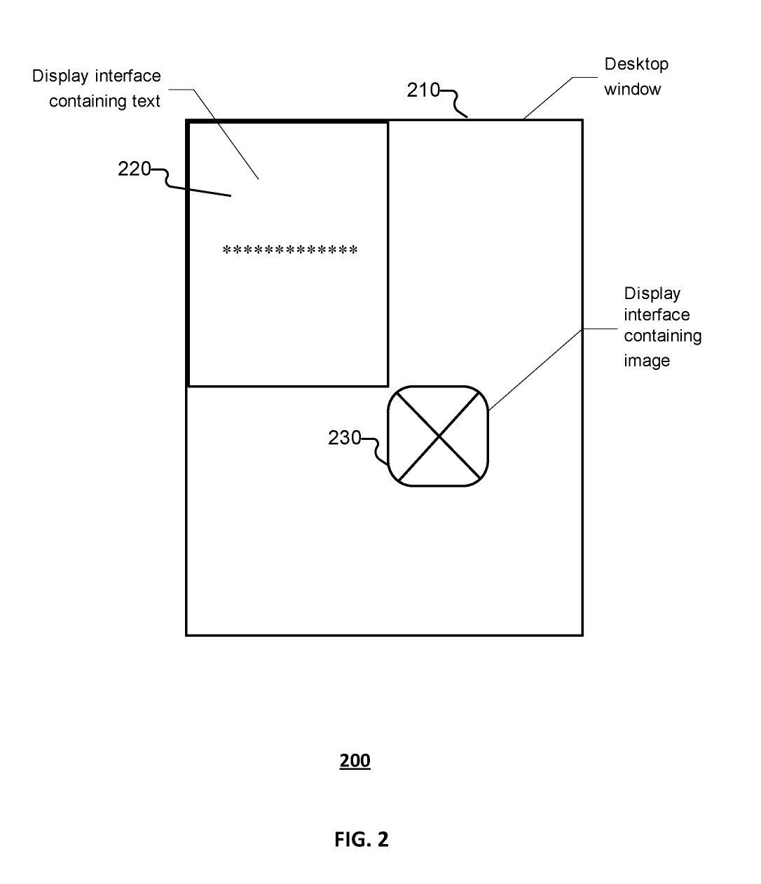

FIG. 2 is a block diagram of a display interface according to various embodiments of the present disclosure.

Referring to FIG. 2, a desktop display interface 200 is provided. Desktop display interface 200 can be created by terminal 510 of system 500 of FIG. 5, or computer system 600 of FIG. 6. For example, terminal 510 can create desktop display interface 200 using information that terminal 510 received from server 520 of system 500 of FIG. 5. Desktop display interface 200 can be created using process 150 of FIG. 1B. For example, in response to receiving and analyzing a data packet received from a server, a mobile terminal can obtain desktop display interface 200, and create one or more display interfaces using information obtained from the analysis of the data packet.

Desktop display interface 200 includes two display interfaces: display interface 220 that includes text and display interface 230 that includes an image. The two display interfaces included in desktop interface 200 can be comprised in desktop 210. For example, desktop interface 200 can include desktop 210, which in turn includes display interface 220 and display interface 230.

In this example, display interface 220 is configured to display text. Further to the example described in connection with process 100 of FIG. 1A, the position of the text component associated with display interface 220 is (0:0:320:460), and the text size is 13 dp. The text color in the image is not shown in this black-and-white figure. The maximum number of text lines for the display interface 220 is one line. The maximum number of text lines of other embodiments can be a different integer value. For example, the maximum number of text lines can be configured according to the component information obtained from the data packet(s). “*” symbols illustrated in display interface 220 are used to indicate display content. The “*” can correspond to the specific desktop service data (e.g., the desktop service data included in the data packet(s) received from the server). In some embodiments, if the user clicks on the text included in display interface 220 (or a portion thereof), then the display interface skips to the content to which the value of the “txtSrc” field points.

Display interface 230 is configured to display an image. Further to the example described in connection with process 100 of FIG. 1A, the position of this image is (320:460:480:600), and the image content corresponds to the content to which the value of the “Imgsrc” field points. An “X” illustrated in display interface 230 is used to indicate that all four corners of the image are rounded.

In some embodiments, before sending a data packet to the mobile terminal, the server can further acquire desktop window information about the mobile terminal (e.g., window resolution, size, etc.). For example, some mobile terminal desktops have full-screen displays. In such cases, the resolution and size of the desktop window corresponds to the resolution and size of the mobile terminal screen. As another example, some mobile terminal desktops do not have full-screen displays, but rather have one area for displaying desktop information. In such cases, the one area is called the desktop window. The server can use the desktop window information to determine interface layout information that is suitable for the particular mobile terminal. For example, many display units could be laid out for a longer window. For a smaller window, however, fewer display units could be laid out, and the UI components would be laid out more compactly in the display units, etc. In some embodiments, interface layout information adapted to desktop window information is set in advance by the server (e.g., the number of display units can vary for different sized windows), thereby enabling different windows in every case to generate reasonable and aesthetically pleasing layouts and achieve optimal display results.

The desktop window information associated with a mobile terminal can be carried in a message sent by the mobile terminal to the server. For example, the mobile terminal can send a message that carries window information when the mobile terminal sends a data request to the server. In some embodiments, the data request sent by the mobile terminal to the server can carry the window information.

In some embodiments, the display interfaces created by the mobile terminal correspond to display IDs carried in the data packets. The mobile terminal can save the correspondence between display IDs and display interfaces. After the mobile terminal analyzes the data packet, the mobile terminal can use the display IDs carried in the data packet to determine whether corresponding display interfaces are present on the desktop first. If the mobile terminal determines that corresponding display interfaces are not present on the desktop, the display interfaces can be created (e.g., according to 180 and 190 of process 150). Conversely, if the mobile terminal determines that the corresponding display interfaces are already present on the desktop, then display interfaces on the desktop do not need to be created.

In some embodiments, the content in the data packet is used directly to update the display interfaces. The updating of existing display interfaces can include merely updating the desktop service data. Alternatively, the updating of existing display interfaces can include reconstructing the display interfaces. If the display interfaces are to be reconstructed, then in addition to updating the desktop service data, UI components therein are recreated based on the interface layout information included in the data packet. The UI component information included in the display units in the interface layout information can be used to create UI components for constructing view containers corresponding to display units. The desktop service data in the data packets can be used to fill the view containers, and the view containers can be rendered in the display interfaces corresponding to the display IDs. To differentiate between these two types of updating (e.g., an update that includes merely updating the desktop service data and an update that includes reconstructing the display interfaces), a set of reconstruction instructions can be carried in the data packet. In some embodiments, if the set of reconstruction instructions indicates that there is a need for reconstruction, the mobile terminal reconstructs the display interface corresponding to the display ID according to (e.g., based at least in part on) the interface layout information in the data packet. If such reconstruction instruction information instructs that only data updating be performed, the mobile terminal only updates the display interface according to the desktop service data in the data packet.

In some embodiments, display interfaces can be deleted. The deletion of display interfaces can be implemented according to an instruction to delete the corresponding display interface or according to expiration information associated with the desktop service data.

In some embodiments, according to the deletion approach in which an instruction to delete the display interface is sent, if a display interface is to be deleted, the display ID corresponding to the display interface to be deleted can be carried in a data packet in conjunction with, or in connection with, instruction information for deleting the display interface in the data packet or an associated data packet. For example, a marker bit can be set in the data packet. The instruction of whether or not to delete the display interface can be provided using the marker bit. If, after the mobile terminal receives a data packet, the data packet is carrying instructions for deleting a display interface, the display interface corresponding to the display ID carried in the data packet is deleted from the desktop.

In some embodiments, according to the deletion approach in which the desktop service data has an expiration associated therewith, expiration status information can be carried in the attribute information of the desktop service data sent from the server to the mobile terminal. For example, the server can send expiration status information associated with the desktop service data in the data packet(s) carrying such desktop service data, or in an associated data packet(s). In the event that expiration status information is communicated in connection with the desktop service data, the corresponding display interface is deleted upon such expiration. For example, the mobile terminal can automatically delete the display interfaces where expired desktop service data is located.

When the mobile terminal is creating a desktop following activation, a display ID corresponding to a display interface can be saved if a display interface was previously created. Thus, the display ID can be carried in the request for service data. When the server receives the request, the server issues a data packet of desktop service data corresponding to this display ID.

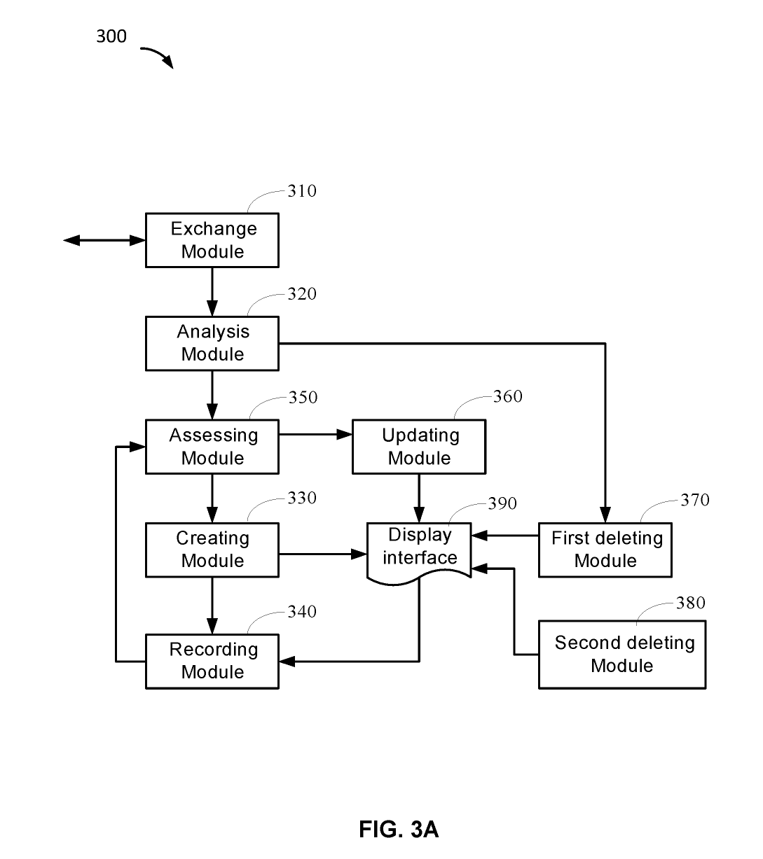

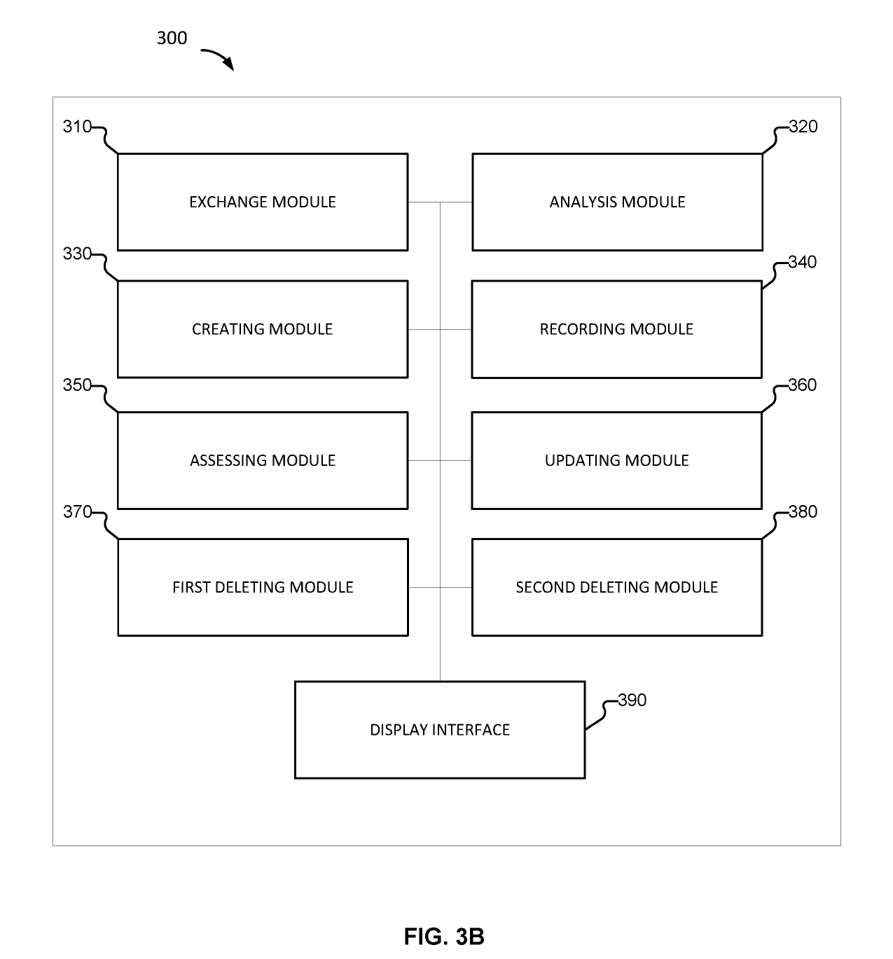

FIG. 3A is a block diagram of a device for implementing a display interface according to various embodiments of the present disclosure. FIG. 3B is a block diagram of a device for implementing a display user interface according to various embodiments of the present disclosure

Referring to FIGS. 3A and 3B, various configurations of device 300 for implementing the display interface are provided. Device 300 can implement the display interface according to process 150 of FIG. 1B. Device 300 can correspond to terminal 510 of system 500 of FIG. 5. In some embodiments, device 300 can be implemented by computer system 600 of FIG. 6.

Device 300 can include an exchange module 310, an analysis module 320, a creating module 330, a recording module 340, an assessing module 350, an updating module 360, a first deleting module 370, a second deleting module 380, a display interface 390, or any combination thereof.

The exchange module 310 is configured to communicate with a server. For example, the exchange module 310 is oriented towards the server and can receive data packets carrying service data such as desktop service data.

The analysis module 320 is configured to analyze the data packets and to obtain interface layout information and/or desktop service data. The analysis module 320 can analyze the data packets in response to such data packets being received by the exchange module 310.

The creating module 330 is configured to use the interface layout information to create the desktop display interface(s) that display the desktop service data. According to various embodiments, the desktop service data can, depending on the service type, correspond to text data, image data, video data, audio data, etc.

In some embodiments, the interface layout information carried in the data packet comprises: display unit information and UI component information included in the display units. One or more display units can be freely defined through the interface layout information. In some embodiments, each display unit corresponds to a display interface on the desktop. The display interfaces can take the form of canvases and preferably the form of web page canvases (e.g., views).

According to various embodiments, different types of data can be laid out in a single display unit, or the different types of data can be laid out separately in different display units. In some embodiments, the layout (e.g., of the various types of data) is on the server side. For example, if the desktop service data issued by the server contains images and text, then the images and text can be displayed as a single display unit. In such an example, the interface layout information of the issued data packet can contain information for just one display unit, and this display unit could contain textual UI component information and could also contain image UI component information. As another example, if the desktop service data issued by the server contains images and text, then images and text could also be separately displayed in different display units. In such an example, the image display unit could contain image UI component information, and the text display unit could contain text UI component information.

In some embodiments, the display unit information includes configuration information associated with the presentation of interface layout information. For example, the display unit information can include display unit quantity information, display unit position information, etc. The UI component information included in a display unit includes: component type (e.g., image component, text component, etc.), component position, component size, component color, component shape, and other such information. In addition, the UI component information can include response information vis-à-vis user operation events. These user operation events can include but are not limited to user clicking, dragging, or sliding vis-à-vis components. The response information for operation events is used in describing user operation event responses. A typical user operation event is a click event. When a user clicks a component, it is generally a data request event. To reduce the trouble involved in processing the event, it is possible to designate a URL request corresponding to the click event. For example, in response to the user clicking the component, the data corresponding to the URL is requested and/or acquired.

The creating module 330 can be configured to use the UI component information included in the display units to create UI components for constructing view containers corresponding to display units. The desktop service data can be used to fill the view containers, and the view containers can be rendered on the desktop to form display interfaces corresponding to display units. For example, the creating module 330 can initially use UI component information such as component type, position, size, and color to create UI components in memory constituting view containers corresponding to display units. Then data is filled in, and the view containers can be rendered on the desktop, forming display interfaces corresponding to the various display units.

In some embodiments, the display unit information above can include display unit position information. The creating module 330 can determine the position of the display interfaces on the desktop in accordance with the position information of the display units included in the display unit information in connection with the forming of a display interface. By setting position information for display units, the server can flexibly place display interfaces in various positions on the desktop. For example, the setting can be to place a display interface in an eye-catching position such as the center of the desktop. The size of the display interfaces can be adapted according to the layout status of the UI components therein. For example, the size of the display interface should ensure that all UI components in the corresponding view container are accommodated and that preset display ratios are complied with.

Data packets that include desktop service data can further comprise display IDs. The recording module 340 is configured to save a correspondence between the display IDs contained in data packets and display interfaces. For example, the recording module 340 can store a table or other database comprising a mapping between display IDs and display interfaces. In some embodiments, data display IDs are unique identifiers of data linking servers to mobile terminals. The data display IDs can correspond to display interfaces on the desktop. In some embodiments, the data display IDs are used in connection with a mobile terminal making a data request or in connection with the updating of data (e.g., service data).

After the exchange module 310 receives a data packet and the analysis module 320 analyzes the data packet, the assessing module 350 determines whether display interfaces corresponding to display IDs included in the data packet are already present on the desktop. If display interfaces corresponding to display IDs included in the data packet are not already present on the desktop, the assessing module 350 triggers the creating module 330 to create a corresponding display interface(s). The assessing module 350 can trigger the creating module 330 by sending an instruction or other indication to the creating module 330. If display interfaces corresponding to display IDs included in the data packet are already present on the desktop, the assessing module 350 triggers the updating module 360 to update the corresponding display interface(s). The assessing module 350 can trigger the updating module 360 by sending an instruction or other indication to the updating module 360. Upon being triggered by the assessing module 350, the creating module 330 executes an operation of creating display interfaces on the desktop, the display interfaces displaying the desktop service data. Upon being triggered by the assessing module 350, the updating module 360 uses data packets to update display interfaces corresponding to the display IDs.

In some embodiments, if the reconstruction instructions carried in the data packet only include an instruction for data updating, then the updating module 360 uses the desktop service data in the data packet to update the display interfaces. In some embodiments, if the reconstruction instructions carried in the data packet include an instruction for reconstruction, then the updating module 360 uses the interface layout information in the data packet to reconstruct the display interfaces.

The updating module 360, when using the interface layout information in the data packet to reconstruct display interfaces, can use the UI component information contained in display units in the interface layout information to create UI components for constructing view containers corresponding to display units, use the desktop service data in the data packet to fill the view containers, and render the view containers in the display interfaces corresponding to display IDs.

In some embodiments, deletion of display interfaces can be implemented through at least one of the first deleting module 370 and the second deleting module 380.

In some embodiments, if the server wants to delete a display interface, the display ID corresponding to the display interface to be deleted can be carried in a data packet in conjunction with, or in connection with, instruction information for deleting the display interface in the data packet. For example, a marker bit can be set in the data packet or an associated data packet. The instruction of whether or not to delete the display interface can be provided using the marker bit. If the analysis module 320, upon analyzing a data packet sent by the server, identifies a display ID and instruction information for deleting a display interface, then the first deleting module 370 deletes the display interface corresponding to the display ID from the desktop.

In some embodiments, desktop service data expiration status information can be carried in the attribute information of the desktop service data sent from the server to device 300. For example, the server can send expiration status information associated with the desktop service data in the data packet(s) carrying such desktop service data, or in an associated data packet(s). In the event that expiration status information is communicated in connection with the desktop service data, the second deleting module 380 deletes the corresponding display interface upon such expiration.

The data packet containing desktop service data as described above can be actively pushed by the server, or the data packet can be sent in response to a mobile terminal request (e.g., a request sent by device 300). For example, in some embodiments, the exchange module 310 can also be responsible for sending a request containing a display ID to the server.

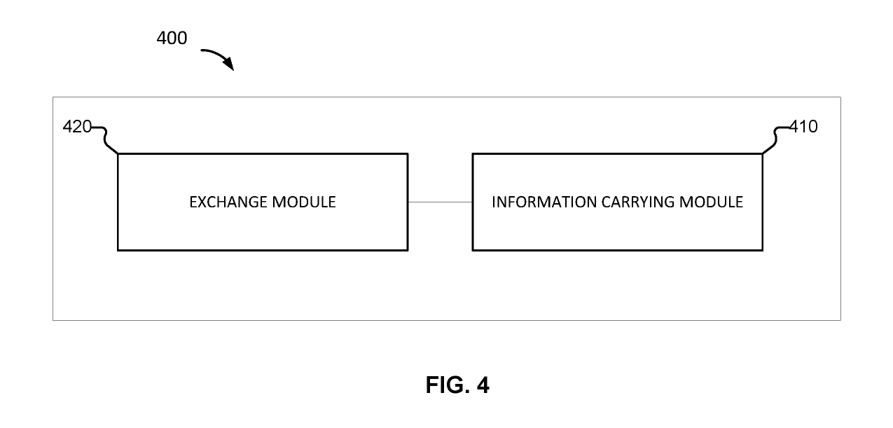

FIG. 4 is a block diagram of a device for implementing a display user interface according to various embodiments of the present disclosure.

Referring to FIG. 4, various configurations of device 400 for implementing the display interface are provided. Device 400 can implement the display interface according to process 100 of FIG. 1A. Device 400 can correspond to server 520 of system 500 of FIG. 5. In some embodiments, device 400 can be implemented by computer system 600 of FIG. 6.

Device 400 can be implemented by or in a server. Device 400 can comprise an information carrying module 410 and an exchange module 420.

The information carrying module 410 is configured to generate a data packet(s). For example, the information carrying module 410 can create interface layout information and include the interface layout information in data packets comprising desktop service data.

The exchange module 420 is configured to send data packets to mobile terminals. The exchange module 420 can be further configured to receive a request (e.g., for service data) from the mobile terminal. The interface layout information is used by a mobile terminal to create on the desktop display interfaces that display the desktop service data.

In some embodiments, data packets sent by the server primarily carry three types of content: desktop service data, interface layout information, and attribute information for desktop service data. Various types of content that can be carried in the data packets are described in connection with FIGS. 1A and 1B.

The information carrying module 410 can configure data packets to include desktop service data display IDs. After the exchange module 420 receives a request containing a display ID sent by a mobile terminal, the exchange module 420 can send a data packet including the display ID and desktop service data to the mobile terminal.

In some embodiments, the exchange module 420 can further acquire desktop window information about the mobile terminal (e.g., window resolution, size, etc.). Such desktop window information can be registered with the server (e.g., device 400) or can be sent in connection with a request for service data. The information carrying module 410 can configure data packets to carry interface layout information adapted to desktop window information and thus enable different windows to generate reasonable and aesthetically pleasing layouts and achieve optimal display results.

If the server wishes to create on the mobile terminal desktop a new display interface to display the desktop service data, then the server can use a new display ID carried in the data packet containing the desktop service data. If a display interface already created on the mobile terminal is to be used to display the desktop service data, the display ID corresponding to the display interface can be included in a data packet including the desktop service data. If no more than updating of the desktop service data is to be performed in this display interface (e.g., if a display interface is not to be created or recreated), then a command can be sent via the reconstruction instructions carried in the data packet to perform nothing but data updating. If reconstruction is to be performed in the display interface, then a command can be given through the reconstruction instructions carried in the data packet to perform reconstruction.

In some embodiments, in order to delete a display interface on the mobile terminal desktop, the expiration status information associated with the desktop service data can be included in the data packets. In some embodiments, the display ID corresponding to the display interface and instructions for deleting the display interface can be carried in the data packet and can instruct the mobile terminal to delete the corresponding display interface(s).

The modules (or sub-modules) described above can be implemented as software components executing on one or more general purpose processors, as hardware such as programmable logic devices and/or Application Specific Integrated Circuits designed to perform certain functions or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices. The functions of the modules may be merged into one another or further split into multiple sub-modules.

A specific application scenario of various embodiments is presented below. For example, it is applied to the card-type desktop that has recently gained popularity. It is possible to use the above-described method and device provided by various embodiments to create a card-type desktop, wherein to create a display interface is to create a service card on the desktop. By using a method or device described above, one can implement the layout of service cards on the desktop and the layout of service data within the service cards. The service data within the service cards can correspond to the desktop service data. According to various embodiments, the layout of service data can be flexibly produced in a service card and displayed in the service card. According to various embodiments, layouts can be separately produced in multiple service cards and display such layouts in the multiple service cards. Moreover, producing the service data layout in the desired (e.g., specified) form is possible.

For example, if movie-type data is to be pushed, this movie-type data can contain stills of the three principal actors and a synopsis of the film. These three stills and the film synopsis could be laid out in one service card. Thus, the interface layout information could contain one display unit, in which each of the three stills and the film synopsis would serve as a UI component within this display unit. The interface layout information would then be issued to the mobile terminal. These three stills could also be laid out in three service cards, respectively. Each service card would display a still and a film synopsis. Thus, the interface layout information could contain three display units, and each display unit would contain an image UI component for a still and a text UI component for the film synopsis. Then the interface layout information would be issued to the mobile terminal.

Various embodiments have the following three advantages.

First, the layout of the desktop display is not constrained by display templates and is not installed on a mobile terminal app. The server can flexibly set the desktop display.

Second, when the desktop layout is to be changed, the server merely needs to change the interface layout information in the data packet. For example, the server is not required to re-abstract and install the template. That greatly reduces the cost.

Third, display interfaces are constructed by creating UI components. Response information vis-à-vis user operation events is defined in UI components. Desktop-based interface display interaction is thereby conveniently achieved.

FIG. 5 is a diagram of a system for implementing a display interface on a mobile terminal according to various embodiments of the present disclosure.

Referring to FIG. 5, system 500 for implementing a display interface is provided. System 500 includes terminal 510, server 520, and network 530. Terminal 510 and server 520 can communicate via network 530. For example, server 520 can send data packet(s) including service data to terminal 510, and terminal 510 can send a request for service data to server 520.

In some embodiments, server 520 implements process 100 of FIG. 1A. In some embodiments, terminal 510 implements process 150 of FIG. 1B.

FIG. 6 is a functional diagram of a computer system for implementing a display interface according to various embodiments of the present disclosure.

Referring to FIG. 6, a computer system 600 for implementing a display interface is displayed. Computer system 600 can implement process 100 of FIG. 1A, process 150 of FIG. 1B, device 300 of FIGS. 3A and 3B or device 400 of FIG. 4. For example, various computer systems 600 can be used to respectively implement terminal 510 and server 520 of FIG. 5. As will be apparent, other computer system architectures and configurations can be used to implement a display interface. Computer system 600, which includes various subsystems as described below, includes at least one microprocessor subsystem (also referred to as a processor or a central processing unit (CPU)) 602. For example, processor 602 can be implemented by a single-chip processor or by multiple processors. In some embodiments, processor 602 is a general purpose digital processor that controls the operation of the computer system 600. Using instructions retrieved from memory 610, the processor 602 controls the reception and manipulation of input data, and the output and display of data on output devices (e.g., display 618).

Processor 602 is coupled bi-directionally with memory 610, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 602. Also as is well known in the art, primary storage typically includes basic operating instructions, program code, data, and objects used by the processor 602 to perform its functions (e.g., programmed instructions). For example, memory 610 can include any suitable computer-readable storage media, described below, depending on whether, for example, data access needs to be bi-directional or uni-directional. For example, processor 602 can also directly and very rapidly retrieve and store frequently needed data in a cache memory (not shown). The memory can be a non-transitory computer-readable storage medium.

A removable mass storage device 612 provides additional data storage capacity for the computer system 600, and is coupled either bi-directionally (read/write) or uni-directionally (read only) to processor 602. For example, storage 618 can also include computer-readable media such as magnetic tape, flash memory, PC-CARDS, portable mass storage devices, holographic storage devices, and other storage devices. A fixed mass storage 620 can also, for example, provide additional data storage capacity. The most common example of mass storage 620 is a hard disk drive. Mass storage device 612 and fixed mass storage 620 generally store additional programming instructions, data, and the like that typically are not in active use by the processor 602. It will be appreciated that the information retained within mass storage device 612 and fixed mass storage 620 can be incorporated, if needed, in standard fashion as part of memory 610 (e.g., RAM) as virtual memory.

In addition to providing processor 602 access to storage subsystems, bus 614 can also be used to provide access to other subsystems and devices. As shown, these can include a display monitor 618, a network interface 616, a keyboard 604, and a pointing device 606, as well as an auxiliary input/output device interface, a sound card, speakers, and other subsystems as needed. For example, the pointing device 606 can be a mouse, stylus, track ball, or tablet, and is useful for interacting with a graphical user interface.

The network interface 616 allows processor 602 to be coupled to another computer, computer network, or telecommunications network using a network connection as shown. For example, through the network interface 616, the processor 602 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 602 can be used to connect the computer system 600 to an external network and transfer data according to standard protocols. For example, various process embodiments disclosed herein can be executed on processor 602, or can be performed across a network such as the Internet, intranet networks, or local area networks, in conjunction with a remote processor that shares a portion of the processing. Additional mass storage devices (not shown) can also be connected to processor 602 through network interface 616.

An auxiliary I/O device interface (not shown) can be used in conjunction with computer system 600. The auxiliary I/O device interface can include general and customized interfaces that allow the processor 602 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 6 is but an example of a computer system suitable for use with the various embodiments disclosed herein. Other computer systems suitable for such use can include additional or fewer subsystems. In addition, bus 614 is illustrative of any interconnection scheme serving to link the subsystems. Other computer architectures having different configurations of subsystems can also be utilized.

It should be understood that the devices and methods that are disclosed in the several embodiments provided above can be realized in other ways. For example, the device embodiment described above is merely illustrative. For example, the delineation of units is merely a delineation according to local function. The delineation can take a different form during actual implementation.

The units described as separate components may or may not be physically separate, and components displayed as units may or may not be physical units. They can be located in one place, or they can be distributed across multiple network units. The embodiment schemes of the present embodiments can be realized by selecting part or all of the units in accordance with actual need.

Furthermore, the functional units in the various embodiments of the present invention can be integrated into one processing unit, or each unit can have an independent physical existence, or two or more units can be integrated into a single unit. The aforesaid integrated units can take the form of hardware, or they can take the form of hardware combined with software function units.

The units described above in which the software function units are integrated can be stored in a computer-readable storage medium. The software function units described above are stored in a storage medium and include a number of commands whose purpose is to cause a piece of computer equipment (which can be a personal computer, a server, or network computer) or a processor to execute some of the steps in the method described in the various embodiments of the present invention. The storage medium described above encompasses: USB flash drive, mobile hard drive, read-only memory (ROM), random access memory (RAM), magnetic disk, or optical disk, or various other media that can store program code.

The preferred embodiments of the present invention that are described above are merely that and do not limit the present invention. Any modification, equivalent substitution, or improvement that is made in keeping with the spirit and principles of the present invention shall be included within the protective scope of the present invention.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a data packet including desktop service data;
obtaining interface layout information from the data packet; and
creating one or more display interfaces on a desktop based at least in part on the interface layout information, wherein the one or more display interfaces display at least a part of the desktop service data.

2. The method of claim 1, wherein the interface layout information comprises display unit information and UI component information included in one or more display units, wherein the one or more display units correspond to a display interface on the desktop.

3. The method of claim 1, wherein the interface layout information comprises display unit information and UI component information included in one or more display units, the one or more display units correspond to a display interface on the desktop, and creating the one or more desktop display interfaces comprises:
creating UI components for constructing view container objects corresponding to the one or more display units based at least in part on the corresponding UI component information;
filling the view container objects using at least a part of the desktop service data; and
rendering the view container objects on the desktop to form display interfaces corresponding to the display units.

4. The method of claim 3, wherein the display unit information includes position information corresponding to the display units, the position information corresponding to information from which positions of the one or more display interfaces provided on the desktop are determined.

5. The method of claim 1, further comprising:
saving a correspondence between one or more data display IDs of desktop service data and one or more display interfaces, wherein at least one of the data display IDs is included in the data packet.

6. The method of claim 5, wherein creating the one or more display interfaces on the desktop based at least in part on the interface layout information that display the desktop service data comprises:
determining whether display interfaces corresponding to the data display IDs are already present on the desktop;
in the event that display interfaces corresponding to the data display IDs are not present on the desktop, creating display interfaces on the desktop based at least in part on the interface layout information, wherein the created display interfaces correspond to the data display IDs and display at least part of the desktop service data; and
in the event that display interfaces corresponding to the data display IDs are present on the desktop, updating the display interfaces corresponding to the data display IDs based at least in part on the data packet.

7. The method of claim 6, wherein updating the display interfaces corresponding to the data display IDs comprises:
in the event that the data packet includes instruction information to update data, using the desktop service data in the data packet in connection with updating the display interfaces; and
in the event that the data packet includes instruction information to reconstruct a display interface, reconstructing the display interfaces corresponding to the data display IDs based at least in part on the interface layout information included in the data packet.

8. The method of claim 7, wherein reconstructing the display interfaces comprises:
creating UI components for constructing view container objects corresponding to display units based at least in part on UI component information included in the display units in the interface layout information;
filling the view container objects based at least in part on the desktop service data in the data packet; and
rendering the view container objects in the display interfaces corresponding to the data display IDs.

9. The method as described in claim 5, further comprising:
sending a request including the data display IDs, wherein the request is sent before the interface layout information is obtained from the desktop service data included in the data packet.

10. The method of claim 1, further comprising:
in response to receiving a data packet comprising data display IDs and instruction information to delete display interfaces, deleting the display interfaces corresponding to the data display IDs from the desktop.

11. The method of claim 1, further comprising:
deleting display interfaces that are provided on the desktop and that correspond to expired desktop service data, wherein the data packet further comprises expiration status information associated with desktop service data.

12. A method, comprising:
configuring a data packet including desktop service data, wherein the data packet includes interface layout information; and
sending the data packet to a mobile terminal, wherein the interface layout information included in the data packet is used by the mobile terminal to create one or more display interfaces that display the desktop service data, and the one or more display interfaces are created on a desktop.

13. The method of claim 12, wherein the interface layout information comprises: display unit information and UI component information included in one or more display units, and the one or more display units correspond to a display interface on the desktop.

14. The method of claim 12, further comprising:
receiving a request including one or more data display IDs of corresponding desktop service data from the mobile terminal, wherein the data packet comprises the one or more data display IDs, and the request is received before the data packet including the desktop service data is sent to the mobile terminal.

15. The method of claim 12, further comprising:
obtaining desktop window information of the mobile terminal,
wherein the data packet includes interface layout information corresponding to the desktop window information.

16. A computer program product, the computer program product being embodied in a non-transitory computer readable storage medium and comprising computer instructions for:
receiving a data packet including desktop service data;
obtaining interface layout information from the data packet; and
creating one or more display interfaces on a desktop based at least in part on the interface layout information, wherein the one or more display interfaces display at least a part of the desktop service data.

17. The computer program product of claim 16, wherein the interface layout information comprises display unit information and UI component information included in one or more display units, wherein the one or more display units correspond to a display interface on the desktop.

18. The computer program product of claim 16, wherein the interface layout information comprises display unit information and UI component information included in one or more display units, the one or more display units correspond to a display interface on the desktop, and creating the one or more desktop display interfaces comprises:
creating UI components for constructing view container objects corresponding to the one or more display units based at least in part on the corresponding UI component information;
filling the view container objects using at least a part of the desktop service data; and
rendering the view container objects on the desktop to form display interfaces corresponding to the display units.

19. The computer program product of claim 18, wherein the display unit information includes position information corresponding to the display units, the position information corresponding to information from which positions of the one or more display interfaces provided on the desktop are determined.

20. The computer program product of claim 16, further comprising instructions for:
saving a correspondence between one or more data display IDs of desktop service data and one or more display interfaces, wherein at least one of the one or more data display IDs is included in the data packet.

21. The computer program product of claim 20, wherein creating the one or more display interfaces on the desktop based at least in part on the interface layout information that display the desktop service data comprises:
determining whether display interfaces corresponding to the data display IDs are already present on the desktop;
in the event that display interfaces corresponding to the data display IDs are not present on the desktop, creating display interfaces on the desktop based at least in part on the interface layout information, wherein the created display interfaces correspond to the data display IDs and display at least part of the desktop service data; and
in the event that display interfaces corresponding to the data display IDs are present on the desktop, updating the display interfaces corresponding to the data display IDs based at least in part on the data packet.

22. The computer program product of claim 21, wherein updating the display interfaces corresponding to the data display IDs comprises:
in the event that the data packet includes instruction information to update data, using the desktop service data in the data packet in connection with updating the display interfaces; and
in the event that the data packet includes instruction information to reconstruct a display interface, reconstructing the display interfaces corresponding to the data display IDs based at least in part on the interface layout information included in the data packet.

23. The computer program product of claim 22, wherein reconstructing the display interfaces comprises:
creating UI components for constructing view container objects corresponding to display units based at least in part on UI component information included in the display units in the interface layout information;
filling the view container objects based at least in part on the desktop service data in the data packet; and
rendering the view container objects in the display interfaces corresponding to the data display IDs.

24. The computer program product of claim 20, further comprising instructions for:
sending a request including the data display IDs, wherein the request is sent before the interface layout information is obtained from the desktop service data included in the data packet.

25. The computer program product of claim 16, further comprising instructions for:
in response to receiving a data packet carrying data display IDs and instruction information for deleting display interfaces, deleting the display interfaces corresponding to the data display IDs from the desktop.

26. The computer program product of claim 16, further comprising instructions for:
deleting display interfaces that are provided on the desktop and that correspond to expired desktop service data, wherein the data packet further comprises expiration status information associated with desktop service data.

27. A computer program product, the computer program product being embodied in a non-transitory computer readable storage medium and comprising computer instructions for:
configuring a data packet including desktop service data, wherein the data packet includes interface layout information; and
sending the data packet to a mobile terminal, wherein the interface layout information included in the data packet is used by the mobile terminal to create one or more display interfaces that display the desktop service data, and the one or more display interfaces are created on a desktop.

28. The computer program product of claim 27, wherein the interface layout information comprises: display unit information and UI component information included in one or more display units, and the one or more display units correspond to a display interface on the desktop.

29. The computer program product of claim 27, further comprising instructions for:
receiving a request including one or more data display IDs of corresponding desktop service data from the mobile terminal, wherein the data packet comprises the one or more data display IDs, and the request is received before the data packet including the desktop service data is sent to the mobile terminal.

30. The computer program product of claim 27, further comprising instructions for:
obtaining desktop window information of the mobile terminal,
wherein the data packet includes interface layout information corresponding to the desktop window information.

31. A system for implementing a desktop, comprising:
at least one processor configured to:
receive a data packet including desktop service data;
obtain interface layout information from the data packet; and
create one or more display interfaces on the desktop based at least in part on the interface layout information, wherein the one or more display interfaces display at least a part of the desktop service data; and
a memory coupled to the at least one processor and configured to provide the at least one processor with instructions.

32. A system for implementing a desktop, comprising:
at least one processor configured to:
configure a data packet including desktop service data, wherein the data packet includes interface layout information; and
send the data packet to a mobile terminal, wherein the interface layout information included in the data packet is used by the mobile terminal to create one or more display interfaces that display the desktop service data, and the one or more display interfaces are created on the desktop; and
a memory coupled to the at least one processor and configured to provide the at least one processor with instructions.
